(19) United States
(12) Patent Application Publication
(10) Pub. No.: US 2014/0267088 A1
(43) Pub. Date: Sep. 18, 2014

(54) TOUCH PANEL PEN THEREOF

(71) Applicant: Chi-Ming Wu, New Taipei City (TW)

(72) Inventor: Chi-Ming Wu, New Taipei City (TW)

(21) Appl. No.: 13/845,103

(22) Filed: Mar. 18, 2013

(51) Int. Cl. G06F 3/033

(52) U.S. Cl. CPC G06F 3/033
USPC 345/173

(57) ABSTRACT

A touch panel pen comprising: a pen is a conductive rod with a connector in front; a fixed stand is a conductive body located in connector of the pen, a through-hole is on the center of the fixed stand and a flange is on the center periphery to separate the fixed stand into front and rear; a conductive textile is convex installed inside the through-hole of the fixed stand, the conductive layer of the conductive textile is formed by vacuum sputtering (physics electroplating) or with no electrolytic plating (chemical plating); a plug is installed inside the through-hole of the fixed stand to stop the conductive textile. By this design, the conductive textile convex installed on the fixed stand formed by vacuum sputtering plating can be thinner in structure, faster in induction; elasticity offers higher accuracy, effectively for more convenience with no wastewater pollution, no environmental problem and no allergy reaction and has antibacterial effect.

### BACKGROUND OF THE INVENTION

1. Field of the Invention

The present invention relates to a touch panel pen thereof, in particular to a touch panel pen by vacuum sputtering plating (physics electroplating) or with no electrolytic electroplating (chemical electroplating) is thinner in structure, faster in induction, elasticity offers higher accuracy, effectively for more convenience with no wastewater pollution, no environmental problem and no allergy reaction and has antibacterial effect thereof.

2. Description of the Related Art

### SUMMARY OF THE INVENTION

In view of the aforementioned problems of the prior art, it is a primary objective of the present invention to provide a touch panel pen thereof, a conductive textile with conductive layer by vacuum sputtering plating (physics electroplating) or with no electrolytic electroplating (chemical electroplating) is convex on the fixed stand with elasticity, thin structure, fast induction, higher accuracy, antibacterial, no wastewater pollution, no environmental problem and no allergy reaction, that overcomes difficulties of existing technology.

The present invention intends to solve the aforementioned problems of the prior art, the regular touch panels are applied on mobile phones, computer products and video games, most people operate with their fingers, however fingers might be too thick for some small icons on touch panel, operation accuracy is not high enough, errors often happen; prior touch panel pens without elasticity easily cause damages to touch panel.

To achieve the foregoing objective, the present invention provides a touch panel pen comprising:

a pen is a conductive rod with a connector in front;

a fixed stand is a conductive body located in the connector of the pen, a through-hole is on the center and a flange is on the center periphery to separate the fixed stand into front and rear;

a conductive textile is convex installed inside the through-hole of the fixed stand; conductive layer is on the conductive textile;

a plug is installed inside the through-hole of the fixed stand to stop the conductive textile.

Wherein, the conductive layer of conductive textile is formed by vacuum sputtering (physics electroplating).

Wherein, the conductive layer of conductive textile is formed with no electrolytic plating (chemical plating).

Wherein, the conductive textile is in bending rolling sphere shape.

Furthermore, another through hole is on the back of the pen.

Furthermore, a rope is on the back of the pen.

By this design, the conductive textile with the conductive layer formed by vacuum sputtering plating (physics electroplating) or with no electrolytic electroplating (chemical electroplating) of the present invention can be thinner in structure, faster in induction, elasticity offers higher accuracy, effectively for more convenience with no wastewater pollution, no environmental problem and no allergy reaction and has antibacterial effect.

### BRIEF DESCRIPTION OF THE DRAWINGS

FIG. 1 is an assembly view of the present invention;

FIG. 2 is a perspective view of the present invention;

FIG. 2A is another perspective view of a touch panel pen in accordance with second preferred embodiment of the present invention;

FIG. 2B is another perspective view of a touch panel pen in accordance with third preferred embodiment of the present invention;

FIG. 3 is a cross sectional view the present invention; and

FIG. 4 is an application view of the present invention.

### DETAILED DESCRIPTION OF THE PREFERRED EMBODIMENTS

The technical content of the present invention will become apparent by the detailed description of the following embodiments and the illustration of related drawings as follows.

With reference to FIG. 1 an assembly view of the present invention, FIG. 2 a perspective view of the present invention and FIG. 3 a cross sectional view of the present invention, the present invention comprises a pen 1, a fixed stand 12, a conductive textile 2 and a plug 13.

The pen 1 is a conductive rod with a connector 11 in front; in this preferred embodiment, the pen 1 is a hollow tube, however it is not limited to any other shapes.

The fixed stand 12 located in connector 11 of the pen 1 and is a conductive body, a through-hole 120 is on the center of the fixed stand and a flange 121 is on the center periphery of the fixed stand 12 to separate the fixed stand 12 into front 122 and rear 123.

The conductive textile 2 is in bending rolling sphere shape, however it is not limited to any other shapes. The conductive textile 2 is convex installed inside the through-hole 120 on the front 122 of the fixed stand 12, conductive layer 21 is on the conductive textile 2, the conductive layer 21 is formed by vacuum sputtering plating (physics electroplating) or with no electrolytic electroplating (chemical electroplating).

The plug 13 is installed inside of the through-hole 120 of the fixed stand 12 to stop the conductive textile 2 from entering the rear 123.

With reference to FIG. 2A another perspective view of the touch panel pen in accordance with the second preferred embodiment of the present invention, FIG. 2B another perspective view of the touch panel pen in accordance with the third preferred embodiment of the present invention and FIG. 4 an application view of the present invention, a fixed stand 12 is on the connector 11 of the pen 1, a conductive textile 2 is convex installed on the front 122 of the fixed stand 12; when the pen 1 contacts the touch panel 3 of resistive type or capacitive type, the touch panel 3 changes the voltage of capacitor or strength of electrical field, the conductive textile 2 with elasticity sinks immediately and returns to bending rolling sphere shape when the contact strength is off; the pen 1, the fixed stand 12 and conductive textile 2 are all conductive, when users hold the pen 1, the whole body can conduct electrically; the conductive layer 21 of the conductive textile 2 convex installed on the fixed stand 12 is formed by vacuum sputtering plating (physics electroplating) or with no electrolytic electroplating (chemical electroplating) can be thinner in structure, faster in induction, elasticity offers higher accuracy, effectively for more convenience with no wastewater pollution, no environmental problem and no allergy reaction and has antibacterial effect. As shown in FIG. 2A, another perspective view of the touch panel pen in accordance with second preferred embodiment of the present invention, however it is not limited to any other shapes, another through hole 110 is on back for a hanging rope 111 as cell phone (as shown in FIG. 2B), however it is not limited to any other shapes.

While the invention has been described by means of specific embodiments, numerous modifications and variations could be made thereto by those skilled in the art without departing from the scope and spirit of the invention set forth in the claims.

What is claimed is:

1. A touch panel pen comprising:
a pen is a conductive rod with a connector in front;
a fixed stand is a conductive body located in connector of said pen, a through-hole is on the center and a flange is on the center periphery to separate said fixed stand into front and rear;
a conductive textile is convex installed inside said through-hole of said fixed stand, conductive layer is on said conductive textile;
a plug is installed on the top of said through-hole of said fixed stand to stop said conductive textile.

2. The touch panel pen of claim 1, wherein a through hole is on the back of said pen.

3. The touch panel pen of claim 2, wherein a hanging rope is on said through hole on the back of said pen.

4. The touch panel pen of claim 1, wherein said conductive layer is formed by vacuum sputtering plating (physics electroplating).

5. The touch panel pen of claim 2, wherein said conductive layer is formed by vacuum sputtering plating (physics electroplating).

6. The touch panel pen of claim 3, wherein said conductive layer is formed by vacuum sputtering plating (physics electroplating).

7. The touch panel pen of claim 1, wherein said conductive layer is formed with no electrolytic electroplating (chemical electroplating).

8. The touch panel pen of claim 2, wherein said conductive layer is formed with no electrolytic electroplating (chemical electroplating).

9. The touch panel pen of claim 3, wherein said conductive layer is formed with no electrolytic electroplating (chemical electroplating).

10. The touch panel pen of claim 1, wherein said conductive textile is in bending rolling sphere shape.

11. The touch panel pen of claim 2, wherein said conductive textile is in bending rolling sphere shape.

12. The touch panel pen of claim 3, wherein said conductive textile is in bending rolling sphere shape.

13. The touch panel pen of claim 4, wherein said conductive textile is in bending rolling sphere shape.

14. The touch panel pen of claim 5, wherein said conductive textile is in bending rolling sphere shape.

15. The touch panel pen of claim 6, wherein said conductive textile is in bending rolling sphere shape.

16. The touch panel pen of claim 7, wherein said conductive textile is in bending rolling sphere shape.

17. The touch panel pen of claim 8, wherein said conductive textile is in bending rolling sphere shape.

18. The touch panel pen of claim 9, wherein said conductive textile is in bending rolling sphere shape.
